(19) United States
(12) Patent Application Publication
(10) Pub. No.: US 2025/0087846 A1
(43) Pub. Date: Mar. 13, 2025

(54) SECONDARY BATTERY

(71) Applicant: Samsung SDI Co., Ltd., Yongin-si (KR)

(72) Inventor: Ye Chan LEE, Yongin-si (KR)

(21) Appl. No.: 18/438,170

(22) Filed: Feb. 9, 2024

(30) Foreign Application Priority Data
Sep. 11, 2023 (KR) 10-2023-0120122

(51) Int. Cl. H01M 50/533; H01M 50/103; H01M 50/15; H01M 50/474; H01M 50/55; H01M 50/557

(52) U.S. Cl. CPC H01M 50/533; H01M 50/103; H01M 50/15; H01M 50/474; H01M 50/55; H01M 50/557

(57) ABSTRACT

The present disclosure relates to a secondary battery. The secondary battery includes a case, a first electrode assembly inside the case, and having a negative electrode substrate tab and a positive electrode substrate tab arranged along a longitudinal direction, a second electrode assembly inside the case, and having a negative electrode substrate tab and a positive electrode substrate tab arranged along the longitudinal direction, a first current collector plate electrically connected to the negative electrode substrate tab of the first electrode assembly and the negative electrode substrate tab of the second electrode assembly, and a second current collector plate electrically connected to the positive electrode substrate tab of the first electrode assembly and the positive electrode substrate tab of the second electrode assembly.

### CROSS-REFERENCE TO RELATED APPLICATION

The present application claims priority to and the benefit of Korean Patent Application No. 10-2023-0120122, filed on Sep. 11, 2023, in the Korean Intellectual Property Office, the entire disclosure of which is incorporated herein by reference.

### BACKGROUND

### 1. Field

The present disclosure relates to a secondary battery.

### 2. Description of the Related Art

A secondary battery may include an electrode assembly that is stacked or wound with a separator interposed between a positive electrode plate and a negative electrode plate, a case that accommodates an electrolyte and the electrode assembly, and a cap assembly coupled to the case. Existing medium-to-large prismatic secondary batteries have a structure in which two negative electrode tabs and two positive electrode tabs are sequentially arranged in one electrode assembly. Such existing secondary batteries are configured such that two negative tabs and two positive tabs are clustered at an upper side of the case in that order, resulting in poor uniformity in applying voltages to upper and lower sides, and resulting in a large difference in heat generation between the upper and lower sides, and there was a problem with cooling.

The above information disclosed in this Background section is only for enhancement of understanding of the background of the disclosure and therefore it may contain information that does not constitute prior art.

### SUMMARY

Embodiments of the present disclosure provide a secondary battery that ensures uniformity of voltage application and has improved heat propagation stability.

A secondary battery according to one or more embodiments of the present disclosure may include a case, a first electrode assembly inside the case, and having a negative electrode substrate tab and a positive electrode substrate tab arranged along a longitudinal direction, a second electrode assembly inside the case, and having a negative electrode substrate tab and a positive electrode substrate tab arranged along the longitudinal direction, a first current collector plate electrically connected to the negative electrode substrate tab of the first electrode assembly and the negative electrode substrate tab of the second electrode assembly, and a second current collector plate electrically connected to the positive electrode substrate tab of the first electrode assembly and the positive electrode substrate tab of the second electrode assembly.

The first current collector plate and the second current collector plate may be spaced apart from each other.

The secondary battery may further include an insulator between the first current collector plate and the second current collector plate.

The first electrode assembly and the second electrode assembly may be spaced apart from each other.

The case may define concave grooves on opposing surfaces thereof.

The grooves may be between the first electrode assembly and the second electrode assembly.

The secondary battery may further include an insulator between the first electrode assembly and the second electrode assembly.

The secondary battery may further include a cap assembly including a cap plate coupled to one side of the case, a first terminal plate on the cap plate and electrically connected to the first current collector plate, and a second terminal plate on the cap plate and electrically connected to the second current collector plate.

The first terminal plate and the second terminal plate may be diagonally arranged with respect to each other.

The first terminal plate and the second terminal plate may be arranged in a substantially straight line with respect to each other.

The first current collector plate may include a first connection part electrically connected to the negative electrode substrate tab of the first electrode assembly, a second connection part electrically connected to the negative electrode substrate tab of the second electrode assembly, and a third connection part electrically connecting the first connection part and the second connection part, and electrically connected to the first terminal plate, wherein the second current collector plate includes a connection part electrically connected to the positive electrode substrate tab of the first electrode assembly, a second connection part electrically connected to the positive electrode substrate tab of the second electrode assembly, and a third connection part electrically connecting the first connection part and the second connection part of the second current collector plate, and electrically connected to the second terminal plate.

The first current collector plate and the second current collector plate may be symmetrical to each other.

In the first current collector plate and in the second current collector plate, the third connection part may have a straight shape, and the first connection part and the second connection part may protrude in a same direction from respective ends of the third connection part.

In the first current collector plate and the second current collector plate, the third connection part may be closer to the cap plate than the first connection part and the second connection part.

The first current collector plate may include a first connection part electrically connected to the negative electrode substrate tab and to the first terminal plate of the first electrode assembly, a second connection part electrically connected to the negative electrode substrate tab of the second electrode assembly, and a connection leg electrically connecting the first connection part and the second connection part, and wherein the second current collector plate includes a first connection part electrically connected to the positive electrode substrate tab of the first electrode assembly, a second connection part electrically connected to the positive electrode substrate tab of the second electrode assembly, and a connection leg electrically connecting the first connection part and the second connection part.

The first current collector plate and the second current collector plate may be symmetrical with each other, wherein the connection leg has a trapezoidal shape.

The first current collector plate and the second current collector plate may be symmetrical with each other, wherein the connection leg has a parallelogram shape.

### BRIEF DESCRIPTION OF DRAWINGS

FIG. 1 is a perspective view showing a secondary battery according to one or more embodiments of the present disclosure.

FIG. 2 is a perspective view of a cap assembly and electrode assemblies according to FIG. 1;

FIG. 3 is an exploded perspective view of first and second electrode assemblies and first and second current collector plates according to FIG. 1.

FIG. 4 is a plan view of the first current collector plate and the second current collector plate according to FIG. 3.

FIG. 5 shows first and second electrode assemblies and an insulator located therebetween according to one or more other embodiments of the present disclosure.

FIG. 6 shows first and second current collector plates and an insulator located therebetween according to one or more other embodiments of the present disclosure.

FIG. 7 is a perspective view showing first and second current collector plates according to one or more other embodiments of the present disclosure.

FIG. 8 is a plan view of the first and second current collector plates according to FIG. 7.

FIG. 9 is a perspective view showing first and second current collector plates according to one or more other embodiments of the present disclosure.

FIG. 10 is a plan view of the first and second current collector plates according to FIG. 9.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to” may be construed similarly. It will be understood that when an element or layer is referred to as being “between” two elements or layers, it can be the only element or layer between the two elements or layers, or one or more intervening elements or layers may also be present.

For the purposes of this disclosure, expressions, such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression, such as “at least one of A and B” and “at least one of A or B” may include A, B, or A and B. As used herein, “or” generally means “and/or,” and the term “and/or” includes any and all combinations of one or more of the associated listed items. For example, the expression, such as “A and/or B” may include A, B, or A and B. Similarly, expressions, such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),”, “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a secondary battery according to one or more embodiments of the present disclosure will be described in detail with reference to the attached drawings.

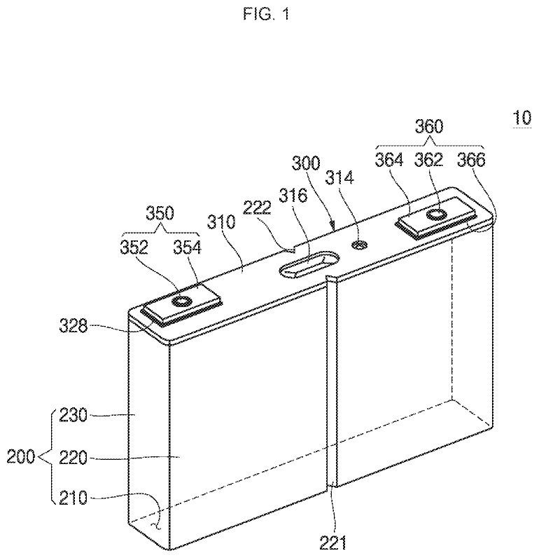

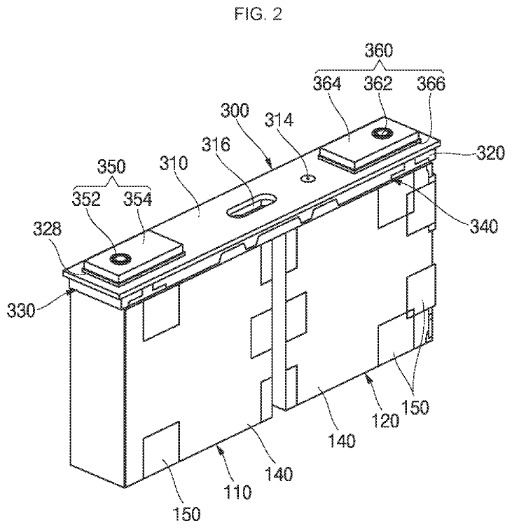

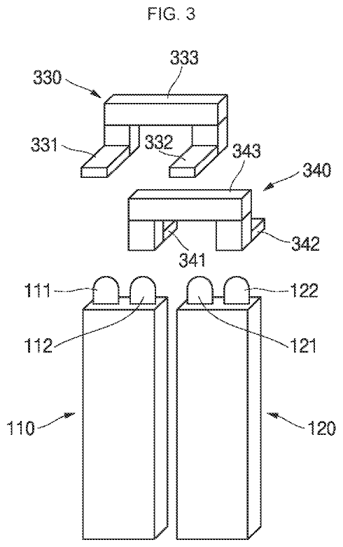

FIG. 1 is a perspective view showing a secondary battery according to one or more embodiments of the present disclosure. FIG. 2 is a perspective view of a cap assembly and electrode assemblies according to FIG. 1. FIG. 3 is an exploded perspective view of first and second electrode assemblies and first and second current collector plates according to FIG. 1. Prior to the following description, for convenience, the upper and lower portions are defined as the upward and downward directions, respectively, based on FIG. 1.

As shown in FIGS. 1 to 3, the secondary battery 10 according to one or more embodiments of the present disclosure may include first and second electrode assemblies 110 and 120, a case 200 accommodating the electrode assemblies 110 and 120, and a cap assembly 300 coupled to the case 200. For example, the secondary battery 10 may be a prismatic battery in which the case 200 has a rectangular parallelepiped shape. However, this is only an example, and the present disclosure can be applied to various types of secondary batteries.

As shown in FIG. 2, the first electrode assembly 110 and the second electrode assembly 120 may be arranged adjacent to each other along the longitudinal direction of the cap assembly 300. The electrode assemblies 110 and 120 may each be provided by winding or stacking a plurality of unit stacks composed of a thin plate-shaped or film-shaped first electrode plate, a second electrode plate, and a separator interposed therebetween. If the electrode assemblies 110 and 120 are formed by being wound, then the winding axis may be arranged in a horizontal direction that is approximately parallel to the longitudinal direction of the cap assembly 300 or in a vertical direction approximately perpendicular to the longitudinal direction of the cap assembly 300. If the electrode assemblies 110 and 120 are formed by stacking, then long side surfaces of a plurality of unit stacks may be arranged to be adjacent to each other. A sheet 140 of an insulating material may be attached to the outside of the electrode assemblies 110 and 120 by using an insulating tape 150 to insulate the electrode assemblies 110 and 120 from the case 200. For example, the first electrode plate may be a negative electrode, and the second electrode plate may be a positive electrode, or vice versa.

If the first electrode plate is a negative electrode plate, then the first electrode plate may be formed by applying a negative electrode active material, such as graphite or carbon to a negative electrode current collector made of a metal foil, such as copper, copper alloy, nickel, or a nickel alloy. A negative electrode uncoated portion, which is an area where the negative electrode active material is not applied, may be formed.

Because the negative electrode uncoated portion serves as a tab electrically connected to the first current collector plate 330, which will be described later, the negative electrode uncoated portions of the first and second electrode assemblies 110 may be defined as first substrate tabs, for example, negative electrode substrate tabs 111 and 121, respectively. A plurality of negative electrode substrate tabs 111 of the first electrode assembly 110, and a plurality of negative electrode substrate tabs 121 of the second electrode assembly 120, may be respectively welded to the first current collector plate 330. The first current collector plate 330 may be electrically connected to the cap assembly 300.

If the second electrode plate is a positive electrode plate, then the second electrode plate may be formed by applying a negative electrode active material, such as a transition metal oxide, to a positive electrode current collector made of a metal foil, such as aluminum or aluminum alloy. A positive electrode uncoated portion, which is an area where the positive electrode active material is not applied, may be formed on the positive electrode plate. Because the positive electrode uncoated portion serves as a tab electrically connected to the second current collector plate 340, which will be described later, the positive electrode uncoated portions of the first and second electrode assemblies 110 may be defined as second substrate tabs, for example, positive electrode substrate tabs 112 and 122, respectively. A plurality of positive electrode substrate tabs 112 of the first electrode assembly 110, and a plurality of positive electrode substrate tabs 122 of the second electrode assembly 120, may be respectively welded to the second current collector plate 340. The second current collector plate 340 may be electrically connected to the cap assembly 300.

The separator may be located between the first electrode plate and the second electrode plate to reduce or prevent the likelihood of a short circuit, and to enable the movement of lithium ions. For example, the separator may include polyethylene, polypropylene, or a composite film of polyethylene and polypropylene, but is not limited to the above-mentioned materials.

The electrode assemblies 110 and 120 of the above-described structure may be accommodated in the case 200 together with an electrolyte. In some examples, the electrolyte may include a lithium salt, such as LiPF6 or LiBF4, in an organic solvent, such as ethylene carbonate (EC), propylene carbonate (PC), diethyl carbonate (DEC), ethyl methyl carbonate (EMC), or dimethyl carbonate (DMC). In some embodiments, the electrolyte may be liquid or gel. In some examples, if an inorganic solid electrolyte is used, the electrolyte may be omitted.

As shown in FIG. 1, the case 200 is shaped of a substantially rectangular box, may have an open upper portion in the longitudinal direction, and may have an accommodating space formed therein. The electrode assemblies 110 and 120 and the electrolyte may be accommodated inside the case 200 through the open upper portion. Some components of the cap assembly 300 may be exposed to the outside of the case 200, and some components may be accommodated inside the case 200. The case 200 may be composed of a rectangular bottom surface 210 and four sides connected to the bottom surface 210. Among the side surfaces, the side having a relatively large area is defined as the long side 220, and the side having a relatively small area is defined as the short side 230. For example, the electrode assemblies 110 and 120 may be arranged so that a relatively large plate surface faces the long side 220. In a state in which the electrode assemblies 110 and 120 are accommodated in the case 200, the cap assembly 300 is coupled to the case 200 and electrically connected to the electrode assemblies 110 and 120.

As shown in FIGS. 1 to 3, the cap assembly 300 may include a cap plate 310 coupled to the case 200, a plurality of insulating members, a first current collector plate 330, a second current collector plate 340, a first terminal part 350, and a second terminal part 360.

The cap plate 310 is shaped of a substantially rectangular plate, and may be formed of the same material as the case 200. In the cap plate 310, terminal holes for coupling the first terminal part 350 and the second terminal part 360, an injection hole 314, and a vent hole for coupling the vent 316, etc., may be formed. For insulation of the cap plate 310 and the electrode assemblies 110 and 120, a plurality of insulating members (e.g., an insulating plate 320) may be provided.

The first current collector plate 330 may electrically connect the first terminal part 350 with the negative electrode substrate tabs 111 and 121 of the first and second electrode assemblies 110. To this end, the first current collector plate 330 may be made of the same material as the negative electrode plates and the negative electrode substrate tabs 111 and 121 of the first and second electrode assemblies 110 and 120. For example, the first current collector plate 330 may be electrically connected to the negative electrode substrate tabs 111 and 121 of the first and second electrode assemblies 110 and 120 through laser welding.

The second current collector plate 340 may electrically connect the positive electrode substrate tabs 112 and 122 of the first and second electrode assemblies 110 and the second terminal part 360. To this end, the second current collector plate 340 may be made of the same material as the positive electrode plates and the positive electrode substrate tabs 112 and 212 of the first and second electrode assemblies 110 and 120. For example, the second current collector plate 340 may be electrically connected to the positive electrode substrate tabs 112 and 122 of the first and second electrode assemblies 110 and 120 through laser welding.

The first terminal part 350 may include a first terminal pin 352 and a first terminal plate 354. The first terminal plate 354 may be insulated from the cap plate 310 by an insulating member 328. The first terminal pin 352 is electrically connected to the first current collector plate 330, and is electrically connected to the negative electrode substrate tabs 111 and 121 of the electrode assemblies 110 and 120.

The second terminal part 360 may include a second terminal pin 362, a second terminal plate 364, and a conductive plate 366. The conductive plate 366 electrically connects the second terminal plate 364, which is electrically connected to the second terminal pin 362, with the cap plate 310. Therefore, the cap plate 310 is connected to the second current collector plate 340 by the second terminal part 360, and is electrically connected to the positive electrode substrate tabs 112 and 212 of the first and second electrode assemblies 110 and 120. In one or more embodiments, the cap plate 310 has the same polarity as the second current collector plate 340, for example, a positive polarity, and the case 200 welded to the cap plate 310 also has a positive polarity.

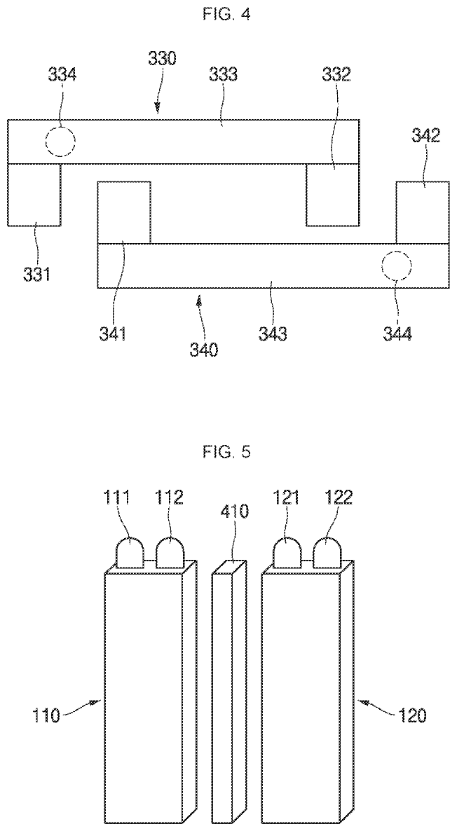

FIG. 4 is a plan view of the first current collector plate and the second current collector plate according to FIG. 3. Referring to FIGS. 3 and 4, the first current collector plate 330 includes a first connection part 331 for electrical connection with the negative electrode substrate tab 111 of the first electrode assembly 110, a second connection part 332 for electrical connection with the negative electrode substrate tab 121 of the second electrode assembly 120, and a third connection part 333 for being connected to the first terminal part 350 (e.g., to the first terminal pin 352). The third connection part 333 may mechanically connect the first connection part 331 and the second connection part 332, and may be electrically connected to the first and second connection parts 331 and 332, respectively. For example, in the first current collector plate 330, the third connection part 333 may have a straight shape, and the first and second connection parts 331 and 332 may be shaped to protrude in the same direction from respective ends of the third connection part 333 (e.g., the first to third connection parts 331, 332, and 333 may approximately form a “U” shape, in plan view). For example, the first and second connection parts 331 and 332 may be formed at heights where the lower surfaces thereof are in contact with the negative electrode substrate tabs 111 and 121 of the first and second electrode assemblies 110 and 120, respectively, and the third connection part 333 may be formed at a height where the upper surface thereof is in contact with the first terminal pin 352 at a higher position than the first and second connection parts 331 and 332. The first to third connection parts 331, 332, and 333 may be formed as a single member, or may be formed as separate members to then be coupled to each other by welding, etc.

Similarly, the second current collector plate 340 includes a first connection part 341 for electrical connection with the positive electrode substrate tab 112 of the first electrode assembly 110, a second connection part 342 for electrical connection with the positive electrode substrate tab 122 of the second electrode assembly 120, and a third connection part 343 for being connected to the second terminal part 360 (e.g., to the second terminal pin 362). The third connection part 343 may mechanically connect the first connection part 341 and the second connection part 342, and may be electrically connected to the first and second connection parts 341 and 342. For example, in the second current collector plate 340, the third connection part 343 may have a straight shape, and the first and second connection parts 341 and 342 may be shaped to protrude in the same direction from both ends of the third connection part 343 (e.g., the first to third connection parts 341, 342, and 342 may form approximately a “U” shape in plan view). For example, the first and second connection parts 341 and 342 may be formed at heights where the lower surfaces thereof are in contact with the positive electrode substrate tabs 112 and 122 of the first and second electrode assemblies 110 and 120, respectively, and the third connection part 343 may be formed at a height where the upper surface thereof is in contact with the second terminal pin 362 at a higher position than the first and second connection parts 341 and 342. The first to third connection parts 341, 342, and 343 may be formed as a single member, or may be formed as separate members to then be coupled to each other by welding, etc.

As shown in FIG. 3, the first and second electrode assemblies 110 and 120 may be arranged adjacent to each other so that the substrate tabs 111, 112, 121, and 122 are arranged in a line, and so that the first and second current collector plates 330 and 340 having the same shape may be spaced apart from each other and arranged in opposite directions. That is, as shown in FIGS. 3 and 4, the third connection parts 333 and 343 of the first and second current collector plates 330 and 340 may be spaced a corresponding distance from each other along the width direction (e.g., the up and down direction in FIG. 4) of the cap plate 310. In some embodiments, the third connection parts 333 and 343 may be arranged parallel to each other along the longitudinal direction (e.g., the left and right directions in FIG. 4) of the cap plate 310. The first and second connection parts 331 and 332 of the first current collector plate 330 may be arranged to face the second current collector plate 340. The first and second connection parts 341 and 342 of the second current collector plate 340 may be arranged to face the first current collector plate 330. Interference during welding can be reduced or prevented by the shape and arrangement of the first and second current collector plates 330 and 340.

As described above, the third connection part 333 of the first current collector plate 330 is electrically connected to the first terminal pin 352 of the first terminal part 350, and includes a first connection area 334 in which connection with the first terminal pin 352 is formed. Likewise, the third connection part 343 of the second current collector plate 340 includes a second connection area 344 in which connection with the second terminal pin 362 of the second terminal part 360 is formed.

Here, the first connection area 334 and the second connection area 344 are formed at respective positions along a direction perpendicular to the longitudinal direction of the cap plate 310, and are diagonally arranged with respect to (e.g., diagonally symmetrical to) each other. As shown in FIG. 1, the first terminal part 350 and the second terminal part 360 (e.g., the first terminal plate 354 and the second terminal plate 364), or the first terminal pin 352 and the second terminal pin 362, may also be located to be diagonal with respect to each other (e.g., with reference to the case 200).

As described above, in the secondary battery 10 according to one or more embodiments of the present disclosure, by including two electrode assemblies 110 and 120 and corresponding current collector plates 330 and 340 separated from each other, and by alternately arranging the negative electrode substrate tabs 111 and 121 and the positive electrode substrate tabs 112 and 122 of the electrode assemblies 110 and 120, likelihood of substantial uniformity of voltage application can be substantially increased. In some embodiments, heat propagation stability can be improved by spacing the first and second electrode assemblies 110 and 120 apart from each other.

Referring again to FIG. 1, the case 200 includes, or defines, grooves 221 and 222 inwardly concavely formed on opposing surfaces of the case 200. The grooves 221 and 222 may be formed between the first and second electrode assemblies 110 and 120. For example, the grooves 221 and 222 may extend in a vertical direction from the center of the long sides 220 of the case 200. The grooves 221 and 222 located between the first and second electrode assemblies 110 and 120 may reduce or prevent interference between the first and second electrode assemblies 110 and 120. In some embodiments, water cooling pipes for cooling can be placed in the grooves 221 and 222, thereby improving cooling performance.

FIG. 5 shows first and second electrode assemblies, and an insulator located therebetween, according to one or more other embodiments of the present disclosure. Referring to FIG. 5, an insulator 410 may be located between the first and second electrode assemblies 110 and 120. Due to the insulator 410, electrical insulation between the first and second electrode assemblies 110 and 120 can be more stably achieved. The shape, size, and location of the insulator 410 shown in FIG. 5 are for a better understanding, and the present disclosure is not limited thereto.

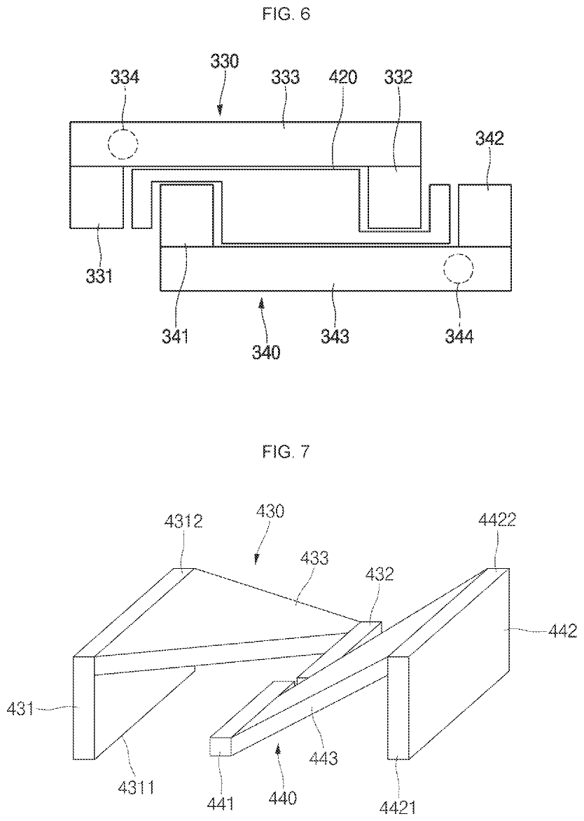

FIG. 6 shows first and second current collector plates and an insulator located therebetween according to one or more other embodiments of the present disclosure. Referring to FIG. 6, an insulator 420 may be located between the first and second current collector plates 330 and 340. Due to the insulator 420, electrical insulation between the first and second current collector plates 330 and 340 can be more stably achieved. The shape, size, and location of the insulator 420 shown in FIG. 6 are for a better understanding, and the present disclosure is not limited thereto.

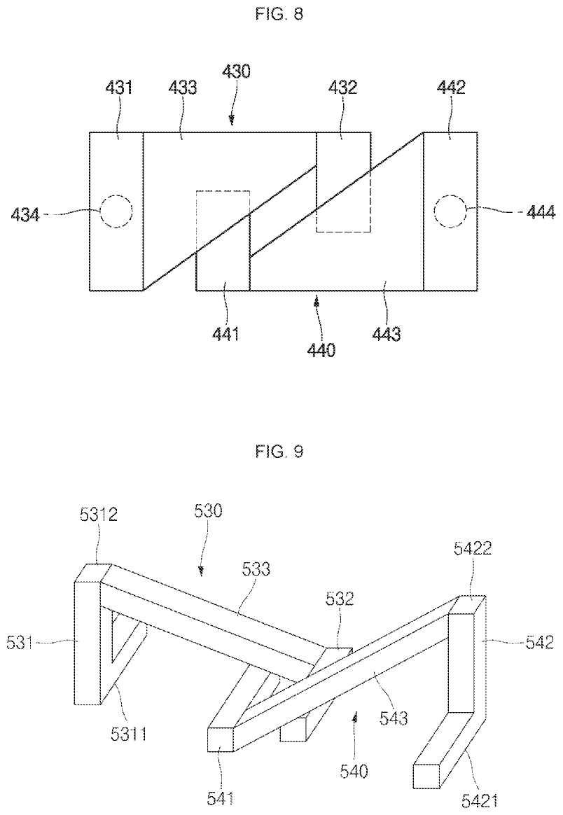

In FIGS. 7 and 8, first and second current collector plates according to one or more other embodiments of the present disclosure are shown. FIG. 7 is a perspective view showing first and second current collector plates according to one or more other embodiments of the present disclosure, and FIG. 8 is a plan view of the first and second current collector plates according to FIG. 7.

In the same manner as previously described in one or more embodiments, a first current collector plate 430 electrically connects the negative electrode substrate tab 111 of the first electrode assembly 110, the negative electrode substrate tab 121 of the second electrode assembly 120, and the first terminal part 350. Also, a second current collector plate 440 electrically connects the positive electrode substrate tab 112 of the first electrode assembly 110, the positive electrode substrate tab 122 of the second electrode assembly 120, and the second terminal part 360.

Referring to FIGS. 7 and 8, the first current collector plate 430 includes a first connection part 431 for electrical connection with the negative electrode substrate tab 111 of the first electrode assembly 110, and for electrical connection with the first terminal part 350 (e.g., with the first terminal pin 352), includes a second connection part 432 for electrical connection with the negative electrode substrate tab 121 of the second electrode assembly 120, and also includes a connection leg 433 that electrically connects the first connection part 431 and the second connection part 432.

The first connection part 431 is formed so that a lower surface 4311 thereof is in contact with the negative electrode substrate tab 111 of the first electrode assembly 110, and so that an upper surface 4312 thereof is in contact with the first terminal pin 352 of the first terminal part 350. The second connection part 432 is formed so that a lower surface thereof is in contact with the negative electrode substrate tab 121 of the second electrode assembly 120. As shown in FIG. 7, the second connection part 432 has a height that is less than the first connection part 431. The connection leg 433 connects the first connection part 431 and the second connection part 432. Here, the connection leg 433 may have a trapezoidal shape (e.g., in plan view) in which the height (e.g., length, in plan view), decreases and the width decreases toward the second connection part 432. The first connection part 431, the second connection part 432, and the connection leg 433 may be formed as a single member, or may be formed as separate members coupled to each other by welding, etc.

As shown in FIGS. 7 and 8, the second current collector plate 440 has the same shape as the first current collector plate 430, and may be arranged to be symmetrical to each other. The second current collector plate 440 includes a first connection part 441 for electrical connection with the positive electrode substrate tab 112 of the first electrode assembly 110, includes a second connection part 442 for electrical connection with the positive electrode substrate tab 122 of the second electrode assembly 120 and for electrical connection with the second terminal pin 362, and includes a connection leg 443 that electrically connects the first connection part 441 and the second connection part 442.

The first connection part 441 is formed so that a lower surface thereof is in contact with the positive electrode substrate tab 112 of the first electrode assembly 110. The second connection part 442 may be formed so that a lower surface 4421 is in contact with the positive electrode substrate tab 122 of the second electrode assembly 120, and so that an upper surface 4422 is in contact with the second terminal pin 362 of the second terminal part 360. As shown in FIG. 7, the first connection part 441 has a height that is less than the second connection part 442. The connection leg 443 connects the first connection part 441 and the second connection part 442. Here, the connection leg 443 may have a trapezoidal shape (e.g., in plan view) in which the height (e.g., length, in plan view) decreases and the width decreases toward the first connection part 441. The first connection part 441, the second connection part 442, and the connection leg 443 may be formed as a single member, or may be formed as separate members coupled to each other by welding, etc.

The first current collector plate 430 and the second current collector plate 440 having the aforementioned shapes and structures are arranged to partially overlap if viewed from the top, as shown in FIG. 8. Therefore, a first connection region 434 that is in contact with the first terminal pin 352 of the first terminal part 350, and a second connection region 444 that is in contact with the second terminal pin 362 of the second terminal part 360, may be located in a substantially straight line with respect to each other. In one or more embodiments, the first terminal part 350 and the second terminal part 360 (e.g., the first terminal plate 354 and the second terminal plate 364, or the first terminal pin 352 and the second terminal pin 362) may also be located in a substantially straight line with respect to each other.

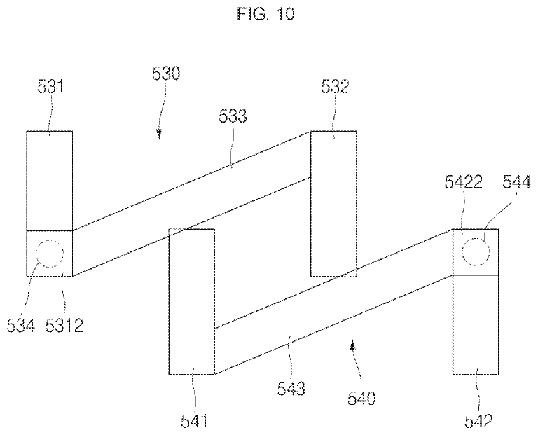

In FIGS. 9 and 10, first and second current collector plates according to one or more other embodiments of the present disclosure are shown. FIG. 9 is a perspective view showing first and second current collector plates according to one or more other embodiments of the present disclosure, and FIG. 10 is a plan view of the first and second current collector plates according to FIG. 9.

In the same manner as one or more previously described embodiments, a first current collector plate 530 electrically connects the negative electrode substrate tab 111 of the first electrode assembly 110, the negative electrode substrate tab 121 of the second electrode assembly 120, and the first terminal part 350. A second current collector plate 540 electrically connects the positive electrode substrate tab 112 of the first electrode assembly 110, the positive electrode substrate tab 122 of the second electrode assembly 120, and the second terminal part 360.

Referring to FIGS. 9 and 10, the first current collector plate 530 includes a first connection part 531 for electrical connection with the negative electrode substrate tab 111 of the first electrode assembly 110 and the first terminal part 350 (e.g., and the first terminal pin 352), includes a second connection part 532 for electrical connection with the negative electrode substrate tab 121 of the second electrode assembly 120, and includes a connection leg 533 that electrically connects the first connection part 531 and the second connection part 532.

The first connection part 531 may substantially have an ‘L’ shape. The first connection part 531 may be formed so that a lower surface 5311 is in contact with the negative electrode substrate tab 111 of the first electrode assembly 110, and may have an upper surface 5312 that is in contact with the first terminal pin 352 of the first terminal part 350. The second connection part 532 is formed so that the lower surface thereof is in contact with the negative electrode substrate tab 121 of the second electrode assembly 120. As shown in FIG. 9, the second connection part 532 has a height that is less than the first connection part 531. The connection leg 533 connects the first connection part 531 and the second connection part 532. Here, the connection leg 533 may have a parallelogram shape (e.g., in plan view). The first connection part 531, the second connection part 532, and the connection leg 533 may be formed as a single member, or may be formed as separate members and then coupled to each other by welding, etc.

As shown in FIGS. 9 and 10, the second current collector plate 540 has a similar shape as the first current collector plate 530, and may be arranged to be symmetrical thereto. The second current collector plate 540 includes a first connection part 541 for electrical connection with the positive electrode substrate tab 112 of the first electrode assembly 110, includes a second connection part 542 for electrical connection with the positive electrode substrate tab 122 of the second electrode assembly 120 and for electrical connection with the second terminal pin 362, and includes a connection leg 543 that electrically connects the first connection part 541 and the second connection part 542.

The first connection part 541 is formed so that the lower surface thereof is in contact with the positive electrode substrate tab 112 of the first electrode assembly 110. The second connection part 542 is formed so that the lower surface thereof is in contact with the positive electrode substrate tab 122 of the second electrode assembly 120, and so that an upper surface 5422 is in contact with the second terminal pin 362 of the second terminal part 360. As shown in FIG. 9, the first connection part 541 has a height that is less than the second connection part 542. The connection leg 543 connects the first connection part 541 and the second connection part 542. Here, the connection leg 543 may have a parallelogram shape. The first connection part 541, the second connection part 542, and the connection leg 543 may be formed as a single member, or may be formed as separate members coupled to each other by welding, etc.

The first current collector plate 530 and the second current collector plate 540 having the aforementioned shapes and structures are arranged to partially overlap if viewed from the top (e.g., in plan view), as shown in FIG. 10. Therefore, a first connection region 534 that is in contact with the first terminal pin 352 of the first terminal part 350, and a second connection region 544 that is in contact with the second terminal pin 362 of the second terminal part 360, may be located in a substantially straight line with respect to each other. In one or more embodiments, the first terminal part 350 and the second terminal part 360 (e.g., the first terminal plate 354 and the second terminal plate 364, or the first terminal pin 352 and the second terminal pin 362) may also be located in a substantially straight line with respect to each other.

As described above, according to one or more embodiments of the present disclosure, the secondary battery includes two separate electrode assemblies and two separate current collector plates, and negative electrode substrate tabs and positive electrode substrate tabs of the two electrode assemblies are alternately arranged, thereby increasing the likelihood of substantial uniformity of voltage application. In some embodiments, heat propagation stability can be improved by spacing the two electrode assemblies apart from each other.

While the foregoing embodiments have been described to practice the secondary battery according to the present disclosure, it should be understood that the embodiments described herein should be considered in a descriptive sense only and not for purposes of limitation, and various changes in form and details may be made therein without departing from the spirit and scope of the disclosure as defined by the following claims, with functional equivalents thereof to be included therein.

What is claimed is:

1. A secondary battery comprising:
a case;
a first electrode assembly inside the case, and having a negative electrode substrate tab and a positive electrode substrate tab arranged along a longitudinal direction;
a second electrode assembly inside the case, and having a negative electrode substrate tab and a positive electrode substrate tab arranged along the longitudinal direction;
a first current collector plate electrically connected to the negative electrode substrate tab of the first electrode assembly and the negative electrode substrate tab of the second electrode assembly; and
a second current collector plate electrically connected to the positive electrode substrate tab of the first electrode assembly and the positive electrode substrate tab of the second electrode assembly.

2. The secondary battery as claimed in claim 1, wherein the first current collector plate and the second current collector plate are spaced apart from each other.

3. The secondary battery as claimed in claim 1, further comprising an insulator between the first current collector plate and the second current collector plate.

4. The secondary battery as claimed in claim 1, wherein the first electrode assembly and the second electrode assembly are spaced apart from each other.

5. The secondary battery as claimed in claim 4, wherein the case defines concave grooves on opposing surfaces thereof.

6. The secondary battery as claimed in claim 5, wherein the grooves are between the first electrode assembly and the second electrode assembly.

7. The secondary battery as claimed in claim 1, further comprising an insulator between the first electrode assembly and the second electrode assembly.

8. The secondary battery as claimed in claim 1, further comprising a cap assembly comprising a cap plate coupled to one side of the case, a first terminal plate on the cap plate and electrically connected to the first current collector plate, and a second terminal plate on the cap plate and electrically connected to the second current collector plate.

9. The secondary battery as claimed in claim 8, wherein the first terminal plate and the second terminal plate are diagonally arranged with respect to each other.

10. The secondary battery as claimed in claim 8, wherein the first terminal plate and the second terminal plate are arranged in a substantially straight line with respect to each other.

11. The secondary battery as claimed in claim 9, wherein the first current collector plate comprises:
a first connection part electrically connected to the negative electrode substrate tab of the first electrode assembly;
a second connection part electrically connected to the negative electrode substrate tab of the second electrode assembly; and
a third connection part electrically connecting the first connection part and the second connection part, and electrically connected to the first terminal plate, and
wherein the second current collector plate comprises:
a connection part electrically connected to the positive electrode substrate tab of the first electrode assembly;
a second connection part electrically connected to the positive electrode substrate tab of the second electrode assembly; and
a third connection part electrically connecting the first connection part and the second connection part of the second current collector plate, and electrically connected to the second terminal plate.

12. The secondary battery as claimed in claim 11, wherein the first current collector plate and the second current collector plate are symmetrical to each other.

13. The secondary battery as claimed in claim 12, wherein, in the first current collector plate and in the second current collector plate, the third connection part has a straight shape, and the first connection part and the second connection part protrude in a same direction from respective ends of the third connection part.

14. The secondary battery as claimed in claim 13, wherein, in the first current collector plate and the second current collector plate, the third connection part is closer to the cap plate than the first connection part and the second connection part.

15. The secondary battery as claimed in claim 10, wherein the first current collector plate comprises:
a first connection part electrically connected to the negative electrode substrate tab and to the first terminal plate of the first electrode assembly;
a second connection part electrically connected to the negative electrode substrate tab of the second electrode assembly; and
a connection leg electrically connecting the first connection part and the second connection part, and
wherein the second current collector plate comprises:
a first connection part electrically connected to the positive electrode substrate tab of the first electrode assembly;
a second connection part electrically connected to the positive electrode substrate tab of the second electrode assembly; and
a connection leg electrically connecting the first connection part and the second connection part.

16. The secondary battery as claimed in claim 15, wherein the first current collector plate and the second current collector plate are symmetrical with each other, and
wherein the connection leg has a trapezoidal shape.

17. The secondary battery as claimed in claim 15, wherein the first current collector plate and the second current collector plate are symmetrical with each other, and
wherein the connection leg has a parallelogram shape.
